(19) United States
(12) Patent Application Publication
(10) Pub. No.: US 2021/0127661 A1
(43) Pub. Date: May 6, 2021

(54) Seal Deterrent Assembly

(71) Applicant: Steven Romeiro, Oxnard, CA (US)

(72) Inventor: Steven Romeiro, Oxnard, CA (US)

(21) Appl. No.: 16/669,754

(22) Filed: Oct. 31, 2019

(51) Int. Cl. A01M 29/30

(52) U.S. Cl. CPC A01M 29/30

(57) ABSTRACT

A seal deterrent assembly for deterring seals from climbing onto a structure in a marina includes a rope that is extendable between a floating object and a structure in a marina. A float is provided and a plurality of holes extends through the float. The holes are spaced apart from each other and are distributed along the float. The rope is laceable through the holes in the float for attaching the float to the rope. In this way the float can float in the water adjacent to the structure. A plurality of kelp plants is provided and each of the plants is coupled to and extends away from the float. In this way each of the kelp plants deters seals from climbing onto the structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to deterrent devices and more particularly pertains to a new deterrent device for deterring seals from climbing onto a structure in a marina.

### (2) Description of Related Art including information disclosed under 37 CFR 1.97 and 1.98

The prior art relates to deterrent devices.

### BRIEF SUMMARY OF THE INVENTION

An embodiment of the disclosure meets the needs presented above by generally comprising a rope that is extendable between a floating object and a structure in a marina. A float is provided and a plurality of holes extends through the float. The holes are spaced apart from each other and are distributed along the float. The rope is laceable through the holes in the float for attaching the float to the rope. In this way the float can float in the water adjacent to the structure. A plurality of kelp plants is provided and each of the plants is coupled to and extends away from the float. In this way each of the kelp plants deters seals from approaching the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a seal deterrent assembly according to an embodiment of the disclosure.

FIG. 2 is a bottom view of an embodiment of the disclosure.

FIG. 3 is a perspective in-use view of an embodiment of the disclosure.

### DETAILED DESCRIPTION OF THE INVENTION

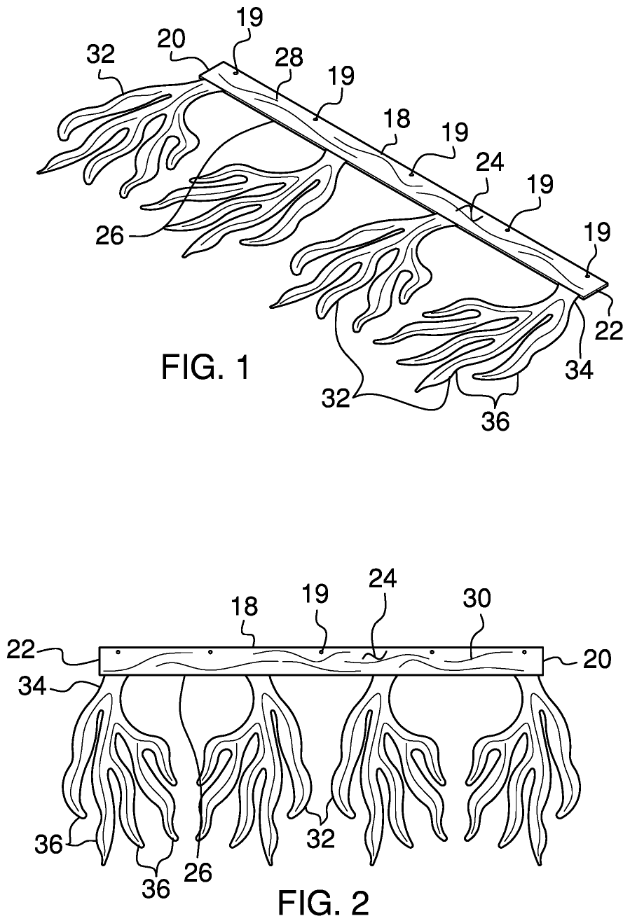

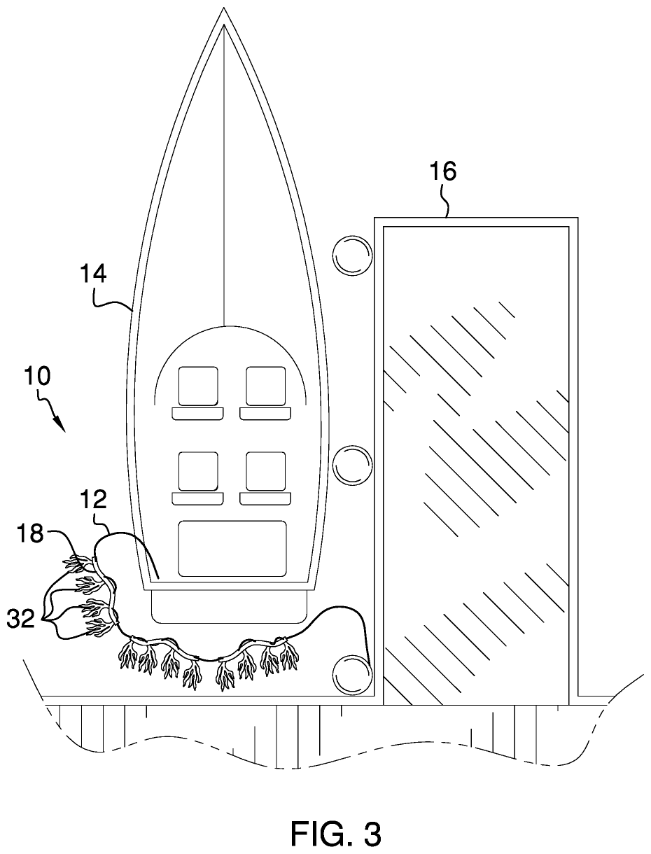

With reference now to the drawings, and in particular to FIGS. 1 through 3 thereof, a new deterrent device embodying the principles and concepts of an embodiment of the disclosure and generally designated by the reference numeral 10 will be described.

As best illustrated in FIGS. 1 through 3, the seal deterrent assembly 10 generally comprises a rope 12 that is extendable between a floating object 14 and a structure 16 in a marina. The floating object 14 may be a boat that is moored in the marina and the structure 16 may be a dock to which the boat is moored. A float 18 is provided that has a plurality of holes 19 extending through the float 18. The holes 19 are spaced apart from each other and are distributed along the float 18. Moreover, the float 18 is comprised of a buoyant material such that the float 18 can float in water. The rope 12 is laceable through the holes 19 in the float 18 for attaching the float 18 to the rope 12 thereby facilitating the float 18 to float in the water adjacent to the structure 16.

The float 18 has a first end 20, a second end 22 and an outer surface 24 extending therebetween. The float 18 has a first edge 26 extending between the first end 20 and the second end 22, and the float 18 is elongated between the first end 20 and the second end 22. The outer surface 24 has a top side 28 and a bottom side 30, and each of the holes 19 extends through the top side 28 and the bottom side 30. The holes 19 are distributed between the first end 20 and the second end 22, and the holes 19 are spaced from the first edge 26.

A plurality of kelp plants 32 is provided and each of the plants 32 is coupled to and extends away from the float 18. In this way each of the kelp plants 32 helps to deter seals from climbing the structure 16. The seals will avoid attempting to climb kelp plants in the wild, thusly facilitating the kelp plants 32 on the float 18 to deter the seals from climbing onto the structure 16.

Each of the kelp plants 32 has a stem 34 and a plurality of leaves 36. The stem 34 of each of the kelp plants 32 is attached to the first edge 26 of the float 18 having the leaves 36 of each of the kelp plants 32 being directed away from the float 18. Moreover, the kelp plants 32 are spaced apart from each other and are distributed between the first end 20 and the second end 22 of the float 18. Each of the kelp plants 32 may be live kelp plants or each of the kelp plants 32 may be artificial kelp plants.

In use, the rope 12 is laced through each of the holes 19 in the float 18 to attach the float 18 to the rope 12. In this way the kelp plants 32 float in the water when the rope 12 is tied between the floating object 14 and the structure 16. Thus, the kelp plants 32 inhibit seals from attempting to climb onto the structure 16 or the floating object 14. Additionally, the rope 12 can be laced through a plurality of the floats 18 thereby facilitating the kelp plants 32 to be distributed along the majority of the length of the rope 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A seal deterrent assembly being configured to inhibit seals from climbing onto docks or boats, said assembly comprising:
a rope being extendable between a floating object and a structure in a marina;
a float having a plurality of holes extending through said float, said holes being spaced apart from each other and being distributed along said float, said float being comprised of a buoyant material wherein said float is configured to float in water, said rope being laceable through said holes in said float for attaching said float to said rope wherein said float is configured to float in the water adjacent to the structure; and
a plurality of kelp plants, each of said plants being coupled to and extending away from said float wherein each of said kelp plants is configured to deter seals from approaching the structure.

2. The assembly according to claim 1, wherein said float has a first end, a second end and an outer surface extending therebetween, said float having a first edge extending between said first end and said second end, said float being elongated between said first end and said second end, said outer surface having a top side and a bottom side, each of said holes extending through said top side and said bottom side, said holes being distributed between said first end and said second end, said holes being spaced from said first edge.

3. A seal deterrent assembly being configured to inhibit seals from climbing onto docks or boats, said assembly comprising:
a rope being extendable between a floating object and a structure in a marina;
a float having a plurality of holes extending through said float, said holes being spaced apart from each other and being distributed along said float, said float being comprised of a buoyant material wherein said float is configured to float in water, said rope being laceable through said holes in said float for attaching said float to said rope wherein said float is configured to float in the water adjacent to the structure, said float has a first end, a second end and an outer surface extending therebetween, said float having a first edge extending between said first end and said second end, said float being elongated between said first end and said second end, said outer surface having a top side and a bottom side, each of said holes extending through said top side and said bottom side, said holes being distributed between said first end and said second end, said holes being spaced from said first edge; and
a plurality of kelp plants, each of said plants being coupled to and extending away from said float wherein each of said kelp plants is configured to deter seals from approaching the structure.

4. The assembly according to claim 3, wherein each of said kelp plants has a stem and a plurality of leaves, said stem of each of said kelp plants being attached to said first edge of said float having said leaves of each of said kelp plants being directed away from said float, said kelp plants being spaced apart from each other and being distributed between said first end and said second end of said float.

5. A seal deterrent assembly being configured to inhibit seals from climbing onto docks or boats, said assembly comprising:
a rope being extendable between a floating object and a structure in a marina;
a float having a plurality of holes extending through said float, said holes being spaced apart from each other and being distributed along said float, said float being comprised of a buoyant material wherein said float is configured to float in water, said rope being laceable through said holes in said float for attaching said float to said rope wherein said float is configured to float in the water adjacent to the structure, said float having a first end, a second end and an outer surface extending therebetween, said float having a first edge extending between said first end and said second end, said float being elongated between said first end and said second end, said outer surface having a top side and a bottom side, each of said holes extending through said top side and said bottom side, said holes being distributed between said first end and said second end, said holes being spaced from said first edge; and
a plurality of kelp plants, each of said plants being coupled to and extending away from said float wherein each of said kelp plants is configured to deter seals from climbing the structure, each of said kelp plants having a stem and a plurality of leaves, said stem of each of said kelp plants being attached to said first edge of said float having said leaves of each of said kelp plants being directed away from said float, said kelp plants being spaced apart from each other and being distributed between said first end and said second end of said float.
